(19) United States
(12) Patent Application Publication
(10) Pub. No.: US 2021/0182899 A1
(43) Pub. Date: Jun. 17, 2021

(54) CREDIT DATA MANAGEMENT METHOD AND APPARATUS, NODE DEVICE, USER EQUIPMENT, STORAGE MEDIUM, AND SYSTEM

(71) Applicant: TENCENT TECHNOLOGY (SHENZHEN) COMPANY LIMITED, Shenzhen (CN)

(72) Inventors: Bo ZHENG, Shenzhen (CN); Qian CHEN, Shenzhen (CN); Peixuan CHEN, Shenzhen (CN)

(21) Appl. No.: 17/169,376

(22) Filed: Feb. 5, 2021

Related U.S. Application Data
(63) Continuation of application No. PCT/CN2019/108609, filed on Sep. 27, 2019.

(30) Foreign Application Priority Data
Oct. 23, 2018 (CN) 201811238453.2

(51) Int. Cl. G06Q 30/02; G06Q 40/02

(52) U.S. Cl. CPC G06Q 30/0242; G06Q 30/0248; G06Q 30/0277; G06Q 40/025

(57) ABSTRACT

A credit data management method includes: acquiring delivery transaction information of a first user, the delivery transaction information indicating information about a delivery transaction of a target content item related to the first user and a second user, the first user being a provider of a target object corresponding to the target content item, and the second user being a deliverer of the target content item; storing delivery contract data in a blockchain of a credit data management system according to the delivery transaction information, the delivery contract data indicating a delivery logic for the target content item and credit data processing information; storing delivery behavior information in the blockchain during a process of delivering the target content item; and processing credit data of the second user according to the credit data processing information when the delivery behavior information does not satisfy the delivery logic in the delivery contract data.

### CROSS-REFERENCES TO RELATED APPLICATIONS

This application is a continuation application of PCT Patent Application No. PCT/CN2019/108609, filed on Sep. 27, 2019, which claims priority to Chinese patent application No. 201811238453.2, entitled “CREDIT DATA MANAGEMENT METHOD AND APPARATUS, NODE DEVICE, USER EQUIPMENT, STORAGE MEDIUM, AND SYSTEM” filed with the China National Intellectual Property Administration on Oct. 23, 2018, the entire contents of both of which are incorporated herein by reference.

### FIELD OF THE TECHNOLOGY

The present disclosure relates to the field of Internet, and in particular, to a credit data management method and apparatus, a node device, a user equipment, a storage medium, and a system.

### BACKGROUND OF THE DISCLOSURE

With the rapid development of the Internet, as a publicity form for rapid dissemination, advertisement delivery based on resource platforms is increasingly popular among advertisers. The advertisers usually perform advertisement delivery through advertising agencies to obtain a best delivery effect. However, it is difficult to monitor the delivery by the advertising agencies. In order to provide better reference for the advertisers in delivery, how to manage credit data of the advertising agencies is increasingly important. Therefore, a credit data management method that can accurately mirror integrity of advertising agencies and ensure delivery authenticity is urgently required.

### SUMMARY

Embodiments of the present disclosure provide a credit data management method and apparatus, a node device, a user equipment, a storage medium, and a system.

A credit data management method performed by a node device includes: acquiring delivery transaction information of a first user through a content item delivery interface, the delivery transaction information indicating information about a delivery transaction of a target content item related to the first user and a second user, the first user being a provider of a target object corresponding to the target content item, and the second user being a deliverer of the target content item; storing delivery contract data in a blockchain of a credit data management system according to the delivery transaction information, the delivery contract data indicating a delivery logic for the target content item and credit data processing information; storing delivery behavior information in the blockchain of the credit data management system during a process of delivering the target content item; and processing credit data of the second user according to the credit data processing information when the delivery behavior information does not satisfy the delivery logic in the delivery contract data.

A node device includes one or more processors and a memory storing at least one computer readable instruction, the computer readable instruction being loaded and executed by the processor to implement: acquiring delivery transaction information of a first user through a content item delivery interface, the delivery transaction information indicating information about a delivery transaction of a target content item related to the first user and a second user, the first user being a provider of a target object corresponding to the target content item, and the second user being a deliverer of the target content item; storing delivery contract data in a blockchain of a credit data management system according to the delivery transaction information, the delivery contract data indicating a delivery logic for the target content item and credit data processing information; storing delivery behavior information in the blockchain of the credit data management system during a process of delivering the target content item; and processing credit data of the second user according to the credit data processing information when the delivery behavior information does not satisfy the delivery logic in the delivery contract data.

One or more non-transitory computer readable storage media storing at least one computer readable instruction, the computer readable instruction being loaded and executed by one or more processors to implement the operations of the credit data management method according to any of the above possible implementations.

A credit data management system includes a plurality of node devices, the same blockchain being provided on the plurality of node devices, the plurality of node devices including a first node device, the first node device being configured to: acquire delivery transaction information of a first user through a content item delivery interface, the delivery transaction information indicating information about a delivery transaction of a target content item related to the first user and a second user, the first user being a provider of a target object corresponding to the target content item, and the second user being a deliverer of the target content item; store delivery contract data in the blockchain according to the delivery transaction information, the delivery contract data being used for indicating a delivery logic for the target content item and credit data processing information; store delivery behavior information in the blockchain during the delivery of the target content item; process credit data of the second user according to the credit data processing information when the delivery behavior information does not satisfy the delivery logic in the delivery contract data; and the plurality of node devices further including a plurality of second node devices, the plurality of second node devices being configured to reach a consensus on information to be stored in the blockchain, and store the information in a blockchain configured for the node devices when the consensus is reached.

Details of one or more embodiments of the present disclosure are provided in the following accompanying drawings and descriptions. Based on the specification, the accompanying drawings, and the claims of the present disclosure, other features, objectives, and advantages of the present disclosure become more apparent.

### BRIEF DESCRIPTION OF THE DRAWINGS

To describe the technical solutions in the embodiments of the present disclosure more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a schematic structural diagram of a credit data management system according to an embodiment of the present disclosure.

FIG. 2 is a flowchart of a credit data management method according to an embodiment of the present disclosure.

FIG. 3 is a schematic diagram of an interface of a credit data management system according to an embodiment of the present disclosure.

FIG. 4 is a schematic diagram of an interface of a credit data management system according to an embodiment of the present disclosure.

FIG. 5 is a schematic diagram of an interface of a credit data management system according to an embodiment of the present disclosure.

FIG. 6 is a schematic diagram of an interface of a credit data management system according to an embodiment of the present disclosure.

FIG. 7 is a schematic diagram of an interface of a credit data management system according to an embodiment of the present disclosure.

FIG. 8 is a schematic diagram of an interface of a credit data management system according to an embodiment of the present disclosure.

FIG. 9 is a schematic diagram of an interface of a credit data management system according to an embodiment of the present disclosure.

FIG. 10 is a schematic diagram of an interface of a credit data management system according to an embodiment of the present disclosure.

FIG. 11 is a flowchart of a credit data management system according to an embodiment of the present disclosure.

FIG. 12 is a schematic structural diagram of a credit data management system according to an embodiment of the present disclosure.

FIG. 13 is a schematic structural diagram of a credit data management apparatus according to an embodiment of the present disclosure.

FIG. 14 is a schematic structural diagram of a content item delivery apparatus according to an embodiment of the present disclosure.

FIG. 15 is a schematic structural diagram of a credit data management apparatus according to an embodiment of the present disclosure.

FIG. 16 is a schematic structural diagram of a credit data management apparatus according to an embodiment of the present disclosure.

FIG. 17 is a structural block diagram of a user equipment according to an embodiment of the present disclosure.

FIG. 18 is a schematic structural diagram of a node device according to an embodiment of the present disclosure.

### DESCRIPTION OF EMBODIMENTS

To make objectives, technical solutions, and advantages of the present disclosure clearer, the following further describes in detail implementations of the present disclosure with reference to the accompanying drawings. It is to be understood that the specific implementations described herein are only used to describe the present disclosure, instead of limiting the present disclosure.

Some terms in the following detailed description are described below.

Advertising agency: a publisher/deliverer of a target content item, which refers to a merchant engaged in or selling advertising channel services, and usually refers to a TV station, a newspaper office, a website, or the like.

Advertiser: a provider of a target object, which refers to legal persons or other economic organizations or individuals that voluntarily commission others to design, produce, and publish advertisements for promoting products or providing services. Any merchant that promotes or sells products or services may be considered as an advertiser. The advertiser publishes an advertising activity, and pays fees to an advertising agency in accordance with a total number of specified marketing effects and a unit effect price in the advertising activity completed by the advertising agency.

Supervisor: an industry association, an independent third-party supervision institution, or an official supervision institution, for example, the consumer association, the State Administration for Industry and Commerce, or the like.

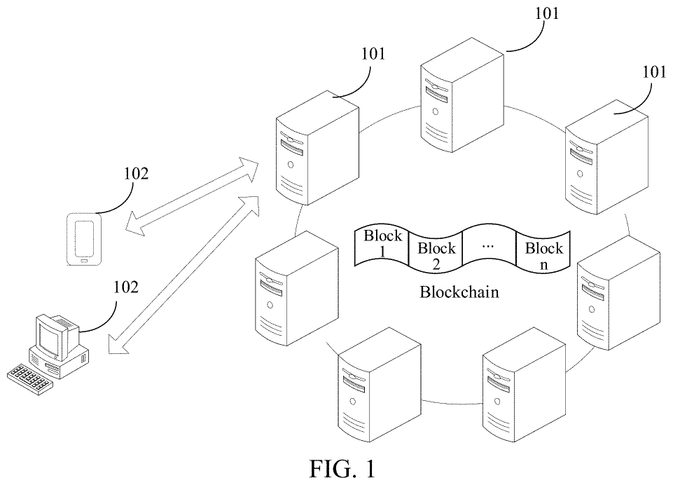

FIG. 1 is a schematic structural diagram of a credit data management system according to an embodiment of the present disclosure. Referring to FIG. 1, the system includes a plurality of node devices 101.

The plurality of node devices 101 may be configured with one blockchain or a plurality of blockchains. In other words, the plurality of node devices 101 may form a blockchain system, and each of the node devices 101 is a node in the blockchain system. The plurality of node devices 101 may belong to the same operating entity, or may belong to different operating entities. For example, the plurality of node devices 101 may include servers of one or more advertising agencies, servers of one or more delivery channels, supervision servers, electronic devices or servers of various advertisers, or the like. The server of the advertising agency may serve as an agency of the plurality of delivery channels. For example, an advertising agency has delivery resources from a plurality of platforms.

For example, the plurality of node devices include at least one first node device. The first node device may be a server of an advertiser. The first node device is configured to: acquire delivery transaction information of a first user through a content item delivery interface, the delivery transaction information being used for indicating a delivery transaction between a first user and a second user that is performed for delivery of a target content item, the first user being a provider of a target object corresponding to the target content item, and the second user being a provider of a delivery service; store delivery contract data in the blockchain according to the delivery transaction information, the delivery contract data being used for indicating a delivery logic for the target content item and credit data processing information; store delivery behavior information in the blockchain during the delivery of the target content item; and process credit data of the second user according to the credit data processing information when the delivery behavior information does not satisfy the delivery logic in the delivery contract data. The plurality of node devices further include a plurality of second node devices. The plurality of second node devices may include servers of one or more delivery channels and supervision servers. The plurality of second node devices are configured to reach a consensus on information to be stored in the blockchain, and store the information in a blockchain configured for the node devices when the consensus is reached. Further, the supervision server may be configured to detect and process received interaction information, usage data, and the like, to manage credit data of users.

FIG. 1 further shows an application environment of a credit data management method according to an embodiment. The application environment includes a user equipment 102. Based on the above application environment provided in FIG. 1, any user may register in a credit data management system when the user needs to use the credit data management system. During the registration, identity verification is required. For example, the identity verification may include the following steps.

The supervision server receives identity information provided by any user equipment 102 during the registration. The identity information may be any information that can identify a user identity on the user equipment 102. For example, the identity information may be a document number, a scanned copy of a document card, a user name, a contact number, a contact address, and the like. The content of the identity information is not specifically limited in the present disclosure. The supervision server may verify, online or offline, the identity information provided by the user equipment 102, and outputs verification result information, which is transmitted to the user equipment 102. The verification result information is used for indicating whether to grant permission for using the credit data management system to a natural person or a legal person corresponding to the identity information. For example, when it is determined that the identity information is falsified, the permission is not granted. When the verification result information is used for instructing to grant the permission for using the credit data management system to the natural person or the legal person corresponding to the identity information, an account is created for the user in the credit data management system, so that the user can conduct various transactions based on the account after logging into the credit data management system through the user equipment 102.

In addition, the user equipment 102 is configured to access the servers of the above operating entities to perform steps such as content item delivery, credit data query, or the like. The user equipment 102 may be a computer, a smartphone, a tablet computer, or other electronic devices.

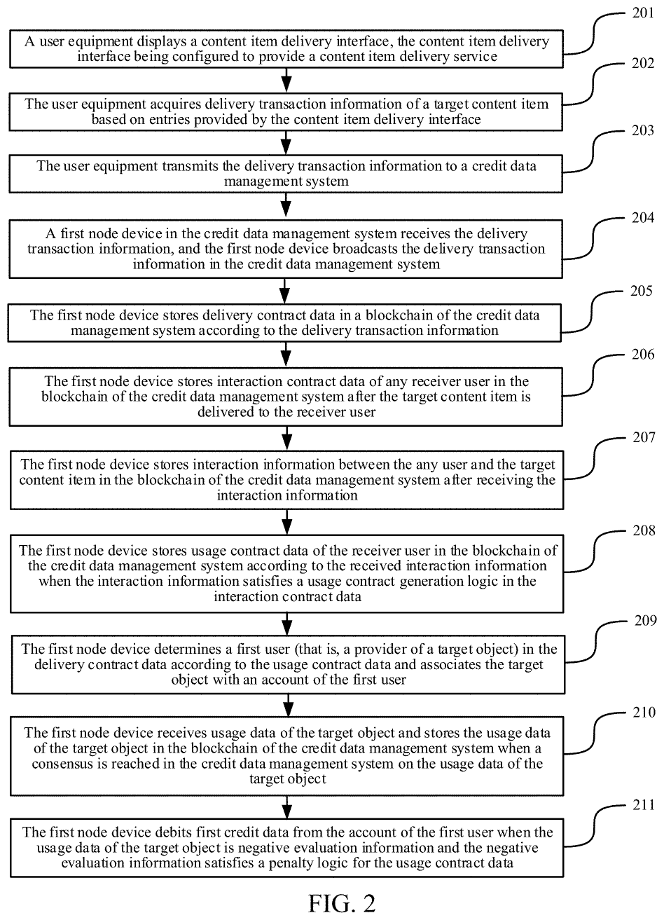

FIG. 2 is a flowchart of a credit data management method according to an embodiment of the present disclosure. Referring to FIG. 2, the embodiment includes the following steps.

201. A user equipment displays a content item delivery interface, the content item delivery interface being configured to provide a content item delivery service, and the user equipment being a device in which a first user performs login.

The target content item corresponds to a target object. The target object includes a commodity or a service. The commodity may be a physical commodity, for example, a household appliance. Certainly, the commodity may also be a virtual commodity, for example, an electronic exchange coupon, or the like. The service may be an offline service or an online service, which is not limited in the embodiments of the present disclosure.

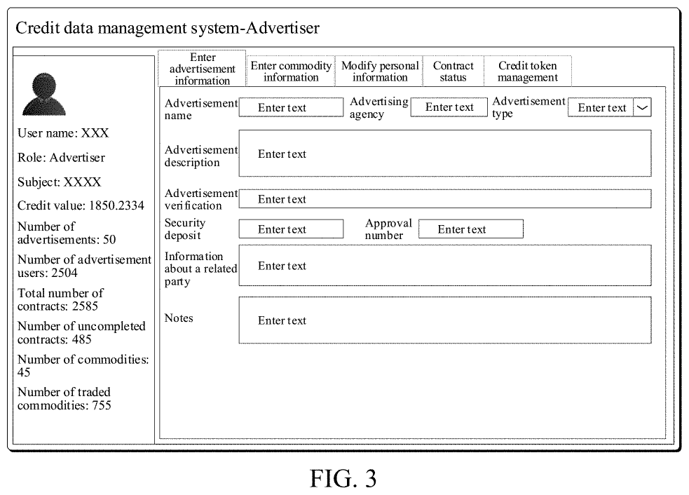

In the embodiments of the present disclosure, the content item delivery interface may provide an input text box related to content item delivery for the first user, so that the first user inputs delivery information, and so on. For example, referring to FIG. 3, an advertiser may enter information related to a target content item in the content item delivery interface, for example, an advertisement name, an advertising agency, an advertisement type, advertisement description, advertisement verification, a mortgage amount, an approval number, information about related parties, remarks, and the like. Further, the content item delivery interface may further include information about historical content item delivery of the first user. For example, account information of the first user, for example, a user name, a role, a subject, a credit value, a number of advertisements, a number of advertisement users, a total number of contracts, a number of uncompleted contracts, a number of commodities, a number of traded commodities, and the like may be displayed at a sidebar in a left part of the interface. The total number of contracts is a sum of a number of delivery contract data, a number of interaction contract data, and a number of usage contract data. The number of uncompleted contracts is a sum of a number of uncompleted contract data, a number of uncompleted interaction contract data, and a number of uncompleted usage contract data. The uncompleted delivery contract data means that a termination condition for the delivery contract data is not reached, that is, a playback period or a marketing effect agreed in the delivery contract data is not achieved. The uncompleted interaction contract data means that a user is in interaction of a trigger condition specified in the interaction contract data during the delivery of the target content item. The uncompleted usage contract data means that a termination condition for the usage contract data is not reached, that is, a shelf life of the target object is not reached or a user returns the commodity. The mortgage amount is a legal tender endorsement that needs to be paid by each participant when any contract data is generated. When a behavior of the participant conforms to a credit data penalty logic agreed in the contract data, a claimant may process corresponding legal tender compensation from the mortgage amount after debit of credit data of the participant.

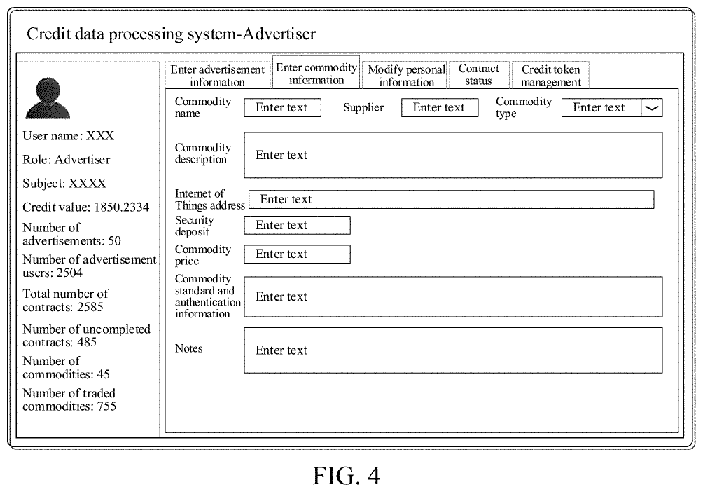

The first user may further enter information related to the target object, for example, a commodity name, a supplier, a commodity type, commodity description, an Internet of Things address, a mortgage amount, a commodity price, a commodity standard, authentication information, remarks, and the like in the content item delivery interface through an interface shown in FIG. 4.

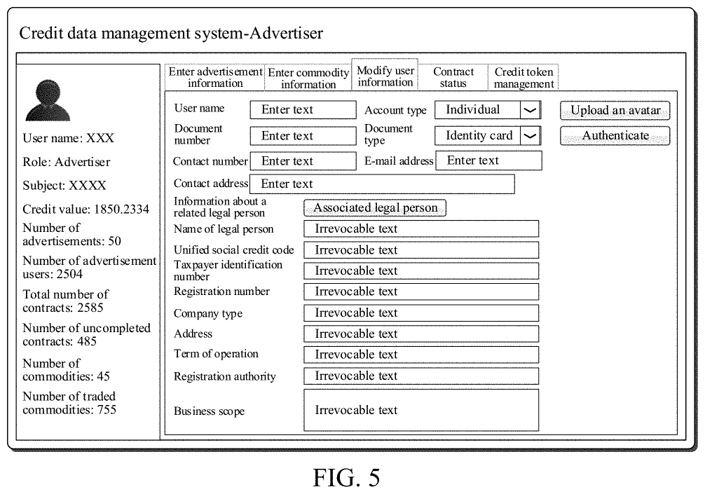

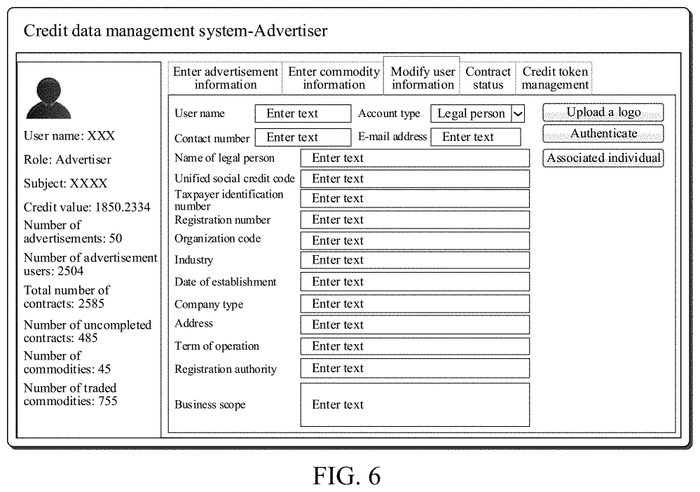

When an account number of the first user which is an advertiser is a natural person account number, the first user may further modify user information through an interface as shown in FIG. 5, and may associate an account of the natural person with a legal person account belonging to the first user. When the account number of the first user is a legal person account number, the first user may make the above modification based on an interface of FIG. 6, and may associate the legal person account number with a natural person account number.

Both an advertising agency and a user may modify user information through similar interfaces. In the embodiments of the present disclosure, only a user information modifying interface for an advertiser is given by way of example.

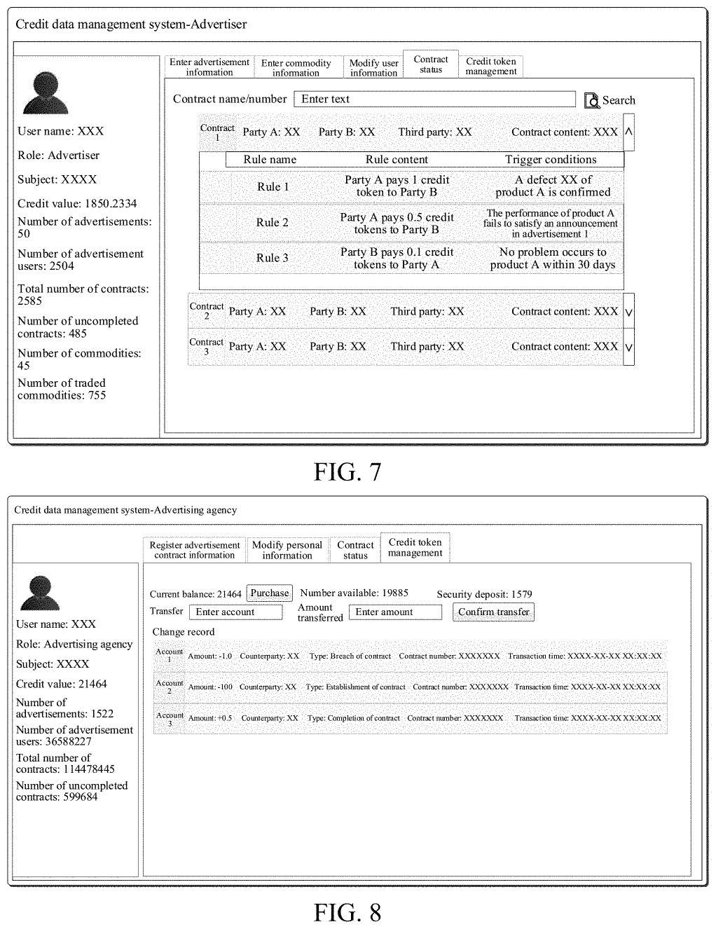

The first user may further view status of any contract data in the credit data management system. Referring to FIG. 7, for a first user, since the target content item is delivered to terminals of a plurality of users, interaction contract data may be generated with respect to each user. In addition, when usage contract data is generated between the user and the target object, the usage contract data is associated with the account number of the first user, or a contract number may be searched for to view the status of the target contract data.

Both an advertising agency and a user may view the contract status through similar interfaces. In the embodiments of the present disclosure, only a contract status viewing interface in an account number of an advertiser is only given by way of example.

202. The user equipment acquires delivery transaction information of a target content item based on various entries provided by the content item delivery interface.

In the embodiments of the present disclosure, only a first user is used to represent a provider of a target object, for example, an advertiser, and a second user is used to represent a provider of a delivery service, for example, an advertising agency. The expression “providing” means to provide delivery resources, for example, provide an advertisement delivery period of time on a live streaming platform, or the like. The target content item is a content item of the target object provided by the first user, for example, an advertisement item. The advertisement item may be a text advertisement or a multimedia advertisement, which is not limited in the embodiments of the present disclosure. The delivery transaction information is used for indicating a delivery transaction conducted between the first user and the second user that is performed for delivery of the target content item. For example, in advertisement delivery, the delivery transaction information carries at least account information of an advertising agency, account information of an advertiser, and a transaction amount.

The user equipment transmits the delivery transaction information to the credit data management system.

The user equipment may be any user equipment having permission for accessing the credit data management system. In the embodiments of the present disclosure, description is only given by way of example that the user equipment delivers content items by accessing the first node device.

204. A first node device in a credit data management system receives the delivery transaction information, and broadcasts the delivery transaction information in the credit data management system, the delivery transaction information being used for indicating a delivery transaction between a provider of a target object and a publisher of the target content item, and the target content item corresponding to the target object.

Step 204 is actually a step of reaching a consensus on the delivery transaction information in the credit data management system. For example, the advertiser requests the advertising agency to advertise the target content item in the credit data management system. The advertising agency makes a consent in response to the delivery request, and then transmits the delivery transaction information of the transaction to all node devices in the credit data management system for broadcasting. After receiving the delivery transaction information, any of the node devices proves a workload for the delivery transaction information to confirm authenticity of the transaction. When a consensus is reached on the delivery transaction information in the credit data management system, the delivery transaction information is stored in the blockchain, and the following step 205 is performed. Application for the above delivery transaction information is performed online and a response is received online. In an embodiment, the advertising agency and the advertiser may also sign a delivery contract offline and then code text content of the delivery contract, to obtain delivery transaction information and delivery contract data, and then enter the delivery transaction information and the delivery contract data into the credit data management system, and the following step 206 is performed. The step of coding the text content of the delivery contract may be performed by using a trained natural language processing technology, and the natural language processing technology may be implemented by a deep neural network.

205. The first node device stores delivery contract data in a blockchain of a credit data management system according to the delivery transaction information, the delivery contract data being used for indicating a delivery logic for the target content item and credit data processing information.

Specifically, the first node device may generate the delivery contract data of the target content item according to the delivery transaction information, and then store the delivery contract data in a blockchain of the first node device. The delivery contract data is a new block generated in the credit data management system based on the delivery transaction information. The new block is a string of binary codes for indicating an agreement reached based on the delivery transaction information. The delivery contract data carries at least the provider of the target object, the publisher of the target content item, and a logic for delivering the target content item.

The logic for delivering the target content item includes at least a channel, a layout position, a playback period of time, playback duration, and a playback cycle for delivering the target content item. The logic for delivering the target content item is not specifically limited in the present disclosure. In an embodiment, the delivery contract data is further used for indicating requirements for delivery of the target content item. The requirements include at least a marketing effect expected by the advertiser, for example, reaching a preset click/tap amount. The preset click/tap amount may be predetermined by the advertiser, or may be set by acquiring an average value of user traffic of the delivery channel during a delivery period of time. The requirements for delivery of the target content item are not specifically limited in the present disclosure.

In an embodiment, the delivery contract data is further used for indicating a termination condition for the delivery contract data, which may be reaching the playback cycle of the target content item. In an embodiment, the termination condition may be reaching the marketing effect expected by the advertiser. Alternatively, in an embodiment, the termination condition may be reaching either the playback cycle or the marketing effect.

Step 205 is actually a step of reaching a consensus on the delivery contract data in the credit data management system. After generating delivery contract data, the first node device needs to broadcast the delivery contract data to all of the node devices in the credit data management system. After receiving the delivery contract data, any of the node devices proves a workload for the delivery contract data. After a consensus is reached on the delivery contract data in the credit data management system, the delivery contract data is stored in the blockchain. All contract data can be recorded in the blockchain only after the above consensus process.

In an embodiment, a credit balance sheet is generated in the blockchain for maintaining a total credit value of each account. After a consensus is reached on a new block, a credit balance sheet of each account may be updated on the credit balance sheet according to credit data included in the new block. In an embodiment, after a credit query instruction for any account is received from any user equipment, a total credit value of the account in the credit balance sheet is returned to the user equipment. Certainly, the user equipment performing querying may have permission for accessing the blockchain. For example, when the user transmits a credit query instruction, a public key of the user equipment may be carried in the credit query instruction. After receiving the credit query instruction, any of the node devices may verify the public key of the user equipment, and may provide the total credit value of the account for the user equipment in response to the credit query instruction when the verification succeeds.

Further, the credit balance table may not be maintained in the blockchain, and the first node device may also acquire credit data of the account from each block of the blockchain in real time when the credit query instruction is received, to calculate a current total credit value of the account to be returned to the user equipment. How to acquire the total credit value is not specifically limited in the embodiments of the present disclosure.

In an embodiment, before the receiving delivery contract data, the method further includes: receiving a query instruction of any user equipment, the inquiry instruction being used for querying credit data of any account; and returning the credit data of any account to the user equipment. In other words, since credit data of all accounts are stored in the blockchain, based on traceability of the blockchain, all historical credit data balance records of transaction parties can be queried in the credit data management system before any transaction. In fact, credit data of any account in the credit data management system can be queried at any time, and a timing of the query operation is not specifically limited in the present disclosure.

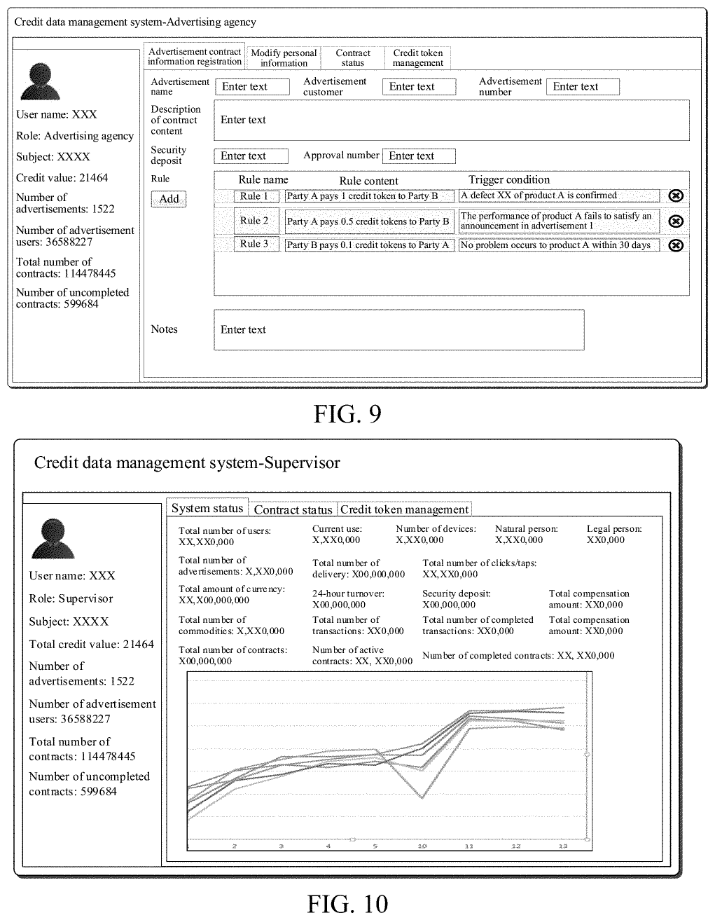

The second user which is an advertising agency may view credit data balance details, a credit data balance, a mortgage amount, and the like of the account in the credit data management system, and may further transfer credit data of a target amount. For example, as shown in FIG. 8, both the advertiser and the user may query credit data accounts through similar interfaces. Only a credit data account querying interface for an advertiser account is given by way of example in the embodiments of the present disclosure. Certainly, as shown in FIG. 9, the second user may further register any contract data in the credit data management system and embed a credit data processing logic for a contract.

206. The first node device stores interaction contract data of any receiver user in the blockchain of the credit data management system after the target content item is delivered to the receiver user, the interaction contract data being used for indicating an interaction processing logic for the target content item.

The interaction contract data is used for indicating that which step is to be performed when any interaction information of the receiver user based on the target content item is received. For example, when transaction information for the target content item is received, the step of generating usage contract data is performed. Step 206 is actually a step in which the first node device generates the interaction contract data based on the delivery and the receiver user to which the target content item is successfully delivered, while delivering the target content item. In order to trace the delivery contract data, the interaction contract data may include a contract identification code of the delivery contract data.

In an embodiment, the above delivery process may also be performed offline. An advertising agency delivers the target content item offline in a corresponding delivery channel according to rules agreed in the delivery contract data. The advertising agency provides evidence indicating successful delivery to a supervision server through the first node device. After the supervision server verifies that there is no error, information about the successful delivery is broadcast to all of the node devices for a consensus is reached and confirmation, to generate interaction contract data. For example, successful delivery means that the target content item can be browsed on the channel. When the advertising agency transmits a delivery instruction but the target content item does not start to be delivered, successful delivery cannot be determined.

Based on above step 201 to step 206, the delivery logic may include a plurality of delivery steps or delivery restrictions, and credit data processing information may correspond to any of the delivery steps or the delivery restrictions. Different delivery steps or delivery restrictions may correspond to different credit data processing information. When delivery behavior information does not satisfy any delivery step or delivery restriction in the delivery contract data, the credit data of the second user may be processed according to corresponding credit data processing information. For example, when the actual delivery channel of the target content item is different from that defined in the delivery contract data, 10 credit values are debited from an account of the second user. However, when a layout position at which the target content item is actually delivered is different from that defined in the delivery contract data, 5 credit values are debited from the account of the second user. Certainly, the same amount of credit data may also be debited when any of the conditions is not satisfied, which is not limited in the embodiments of the present disclosure. Accordingly, based on an actual delivery process, the method may include: the first node device may further store delivery behavior information in the blockchain of the credit data management system during the delivery of the target content item; and process credit data of the second user according to the credit data processing information when the delivery behavior information does not satisfy the delivery logic in the delivery contract data. The delivery behavior information may be used for indicating how the advertising agency delivers the target content item. When the delivery does not satisfy the agreement between the first user and the second user for the delivery, a penalty may be imposed on the second user. For example, when the credit data processing information is to debit first credit data debited from the account of the second user, the data processing information may be executed to process the credit data of the second user. In a possible implementation, the processing of the credit data of the second user may be implemented by the supervision server instead of the first node device, and the processed credit data of the second user is stored in the credit data management system, so that the credit data of the second user can be queried.

207. The first node device stores interaction information between the user and the target content item in the blockchain of the credit data management system after receiving the interaction information.

The interaction information includes: exposure behavior information, click/tap behavior information, interaction behavior information, and transaction information of the target content item. For example, the exposure behavior information may be that a mouse is moved in a delivery area of the target content item, or that the mouse is stayed on a page of the target content item for preset duration. The click/tap behavior information may indicate that the user clicks/taps the target content item. The interaction behavior may be that the user fills in information such as a user name, a mobile phone number, an address, and the like on the page corresponding to the target content item, or that the user participates in a minigame provided by the target content item. The transaction information includes at least account information of the advertiser, account information of the user, a number of transactions, a transaction amounts, a delivery address, and the like. Specific content of the interaction behavior is not specifically limited in the present disclosure.

The above step 204 is actually that the user equipment transmits the exposure behavior information to the credit data management system when the user equipment detects an exposure behavior of the target content item during browsing of the target content item on the user equipment by the user. After receiving the exposure behavior information, the first node device broadcasts the exposure behavior information to all of the node devices in the credit data management system, and records the exposure behavior information to the blockchain after a consensus is reached and confirmation. The broadcasting step may be performed for any of the above interaction information so that each of the node devices in the credit data management system can store received interaction information.

208. The first node device stores usage contract data of the receiver user in the blockchain of the credit data management system according to the interaction information when the received interaction information satisfies a usage contract generation logic in the interaction contract data, the usage contract data being used for indicating a credit data processing logic.

The usage contract data is used for indicating a credit data processing logic for a provider of a target object involved in the usage contract data. Certainly, the usage contract data may be further used for indicating a credit data processing logic for a provider of a delivery service of a target content item involved in the usage contract data, which is not limited in the embodiments of the present disclosure.

When the received interaction information indicates that the user has purchased the target object indicated by the target content item, usage contract data may be generated for the user. The usage contract data may trigger a credit data processing step for the first user based on the received usage data. Further, the usage contract data may further trigger a credit data processing step for the second user based on the received usage data. The credit data processing for the first user and the credit data processing for the second user may also be simultaneously triggered, to impose a credit penalty on both the first user providing an unqualified target object and the second user making a false advertisement.

The usage data is used for indicating a usage behavior of the target object. The usage data includes at least actual usage status and integrity of the target object or service accepting status of the user. The usage data may be transmitted through a status reporting apparatus built in an Internet of Things interface of the node device. The Internet of Things interface is responsible for collecting the usage data of the target object, which includes but is not limited to intelligent home appliances, smartphones, intelligent vehicles, on-line evaluation, intelligent monitoring, and the like. In an embodiment, in absence of an Internet of Things interface, the user provides logistics records or service records to the supervision server through the credit data management system. The usage contract data may be generated after verification by the supervision server succeeds.

In an embodiment, the usage contract data is further used for indicating a termination condition of the usage contract data, for example, the termination condition is an expiration date of the target object. In an embodiment, the termination condition may also be that the user returns a commodity.

209. The first node device determines the first user (that is, a provider of the target object) in the delivery contract data according to the usage contract data, and associates the target object with an account of the first user.

The usage contract data may include a contract identification code of the interaction contract data, and the interaction contract data includes a contract identification code of the delivery contract data. Therefore, an account corresponding to the advertiser in the delivery contract data may be traced based on the usage contract data, thus associating the target object with the account corresponding to the advertiser, that is, associating the target object with the account of the first user.

In an embodiment, after the user browses the target content item but does not purchase the target content item on a hyperlink page to which the target content item jumps, the user may scan a QR code provided on the target content item, and access the interaction contract data in the credit data management system. The QR code is linked to a target information filling interface of the target object when the user has a historical exposure behavior, click/tap behavior, or interaction behavior. The target information includes but is not limited to a production date, an expiration date, a commodity serial number, and the like. In addition, the target object is associated with the account corresponding to the advertiser, so that the user may also be held to account through the credit management system when the user purchases the target object from other purchase channels under a delivery effect of the target content item.

By associating the target object with the account corresponding to the advertiser, the credit data of the advertiser may be processed when the credit data processing logic in the usage contract data is satisfied.

210. The first node device receives usage data of the target object, and stores the usage data of the target object in the blockchain of the credit data management system when a consensus is reached on the usage data of the target object in the credit data management system.

The above step 210 is actually a step of confirming a consensus on the usage data using a proof of work. The proof or work is only used for maintaining the credit data management system. A solution to an algorithm of the proof of work does not generate credit data, that is, all terminals perform free-of-charge mining. The credit data is managed and distributed by a supervisor, and the credit data is interchangeable with a legal tender.

The usage data of the target object may refer to information such as feedback data of the target object, for example, actual operation parameters of the target object, complaint information uploaded by users of the target object, and the like. Certainly, in the embodiments of the present disclosure, the usage data of the target object may also be evaluation information for the target object. The evaluation information for the target object may be negative evaluation information or positive evaluation information obtained by classifying and marking the received usage data of the target object by the supervision server based on the usage contract data in the credit data management system. The first node device performs credit data processing based on the negative evaluation information or positive evaluation information.

When the usage data of the target object is the negative evaluation information, a credit value of the account corresponding to the advertiser may be debited. Alternatively, when the usage data of the target object is the positive evaluation information, a credit value may be awarded to the account corresponding to the advertiser.

A supervisor may monitor status of the credit data management system through an interface shown in FIG. 10, to observe a total number of users, a number of devices, a total number of advertisements, total times of delivery, and a total number of clicks/taps of the credit data management system. Any schematic interface diagram provided in the embodiments of the present disclosure is exemplary description, and a control layout and an appearance design of the interface are not specifically limited in the embodiments of the present disclosure.

211. The first node device debits first credit data from the account of the first user when the usage data of the target object is negative evaluation information and the negative evaluation information satisfies a penalty logic in the usage contract data.

The above step 211 is merely an example of the penalty logic. Second credit data may be further debited from the account of the second user based on a penalty logic for the delivery contract data when the usage data of the target object is negative evaluation information and the negative evaluation information satisfies the penalty logic. When the usage data of the target object is negative evaluation information and the negative evaluation information satisfies the penalty logic in the usage contract data, third credit data may be further transferred from the account of the first user to the account of the user based on the penalty logic. In some embodiments, fourth credit data is added to the account of the first user when the usage contract data further includes an award logic, the usage data of the target object is positive evaluation information, and the positive evaluation information satisfies an award logic in the usage contract data.

Further, for example, when credit data of a natural person or a legal person corresponding to the identity information is less than a first preset value, permission for using the credit data management system granted to the natural person or the legal person is cancelled.

The above credit data management method is illustrated by for example imposing a credit penalty on the first user based on tracing of three kinds of contract data. For example, when generating current contract data based on previous contract data, a contract identification code of the previous traceable contract data may be stored in the current contract data. When generating interaction contract data, a contract identification code of delivery contract data may be added to the interaction contract data, and when generating usage contract data, a contract identification code of the interaction contract data may be added to the usage contract data. Therefore, contracts can be traced back level by level. However, in some embodiments, the method may be illustrated by for example imposing a penalty related to credit data on the second user which breaches the delivery contract data when a delivery logic for the delivery contract data is not satisfied. Specifically, when the received interaction information does not satisfy the delivery logic in the delivery contract data, the credit data of the second user which is an advertising agency is processed according to the credit data processing information. For another example, when the usage logic for the usage contract data is not satisfied, the credit data of the first user or the second user may be triggered according to the credit data processing logic included in the usage contract data. Specifically, the credit data of the first user and/or the second user which is a publisher is processed according to the usage data of the target object and the usage contract data, that is, corresponding credit data processing is performed on both the advertiser and the advertising agency. Specific contract data based on which a credit data penalty is imposed is not limited in the embodiments of the present disclosure. For some embodiments, more penalty conditions may be further defined in each piece of the contract data. When subsequently received interaction information or usage data satisfies the penalty conditions in any contract data, a credit data penalty may be imposed on a corresponding user, which is not limited in the embodiments of the present disclosure.

The above credit data management process may be implemented based on an intelligent contract. The intelligent contract is present in an application layer of the blockchain as a sub-layer, which is present in a newest block in a contract set form, and checks and executes a trigger logic in each consensus process. The intelligent contract can ensure automatic completion of specified actions under agreed conditions. Since related interaction, guarantee, and compensation are bound through the intelligent contract, all subsequent execution is completely automatic without manual intervention, which greatly reduces workloads and reduces labor costs. In addition, distributed confirmation and storage can be achieved in the blockchain, thus greatly improving intelligence and authenticity of the credit data management. Moreover, since the blockchain system is decentralized, the whole system can operate without a fixed server or core node, which is robust, thus avoiding maintenance costs of a centralized server.

According to the method provided in the embodiments of the present disclosure, the delivery contract data is generated in the credit data management system, and delivery behavior of a publisher is bound based on the delivery contract data. When any delivery behavior and delivery contract data fail to satisfy the delivery contract data, a corresponding credit data penalty may be imposed on the publisher. Since the delivery contract data is generated in a blockchain, it is impossible to falsify or tamper with a processing logic for the credit, that is, it is impossible to falsify or tamper with the processing of the credit data based on the processing logic. Therefore, authenticity of the credit data is ensured, and integrity of an advertising agency is accurately mirrored by the credit data.

Further, the delivery contract data is generated in the credit data management system, the interaction contract data is generated based on the delivery contract data, the usage contract data is generated based on the interaction contract data, and credit data of participants of the usage contract data is processed based on the usage data. Since the delivery contract data, the interaction contract data, and the usage contract data are generated in the blockchain, it is impossible to falsify and tamper with the processing logic for the credit data. Therefore, authenticity of the credit data is ensured, and integrity of the advertiser and the user is accurately mirrored by the credit data. Moreover, when the usage data is negative evaluation information, an identification code of any of the above contract data can be accessed in the blockchain through a relationship between the three types of contract data. Credit data of the user, the provider of the target object, and the publisher of target content item is processed according to a credit data processing logic in the contract data, so that the credit data of the user, the advertising agency, and the advertiser can be held to account and managed. Further, since a credit currency and a mortgage mechanism are adopted, losses of the user can be effectively guaranteed and compensated, and a penalty is imposed on a related advertisement publisher or commodity seller, thus achieving traceability and compensation.

Such a credit data management method has high timeliness. By means of the decentralized blockchain network, global synchronization can be achieved within half an hour once related fraudulent advertisement information is confirmed, achieving real-time fraud prevention and control. In addition, since both related interaction information and usage data are stored based on the blockchain and cannot be tampered with, previous information cannot be modified but only be explained through subsequent supplementary information once a record is generated, thus fundamentally avoiding possibility of malicious tampering of the record. The method further achieves extensive information exchange in a case of being applied to credit management, thus completely fighting against fraudulent advertisements through information sharing and combination. Various advertising platforms and companies can prevent sneaking of fraudulent advertisements, and users can also effectively avoid suspicious information.

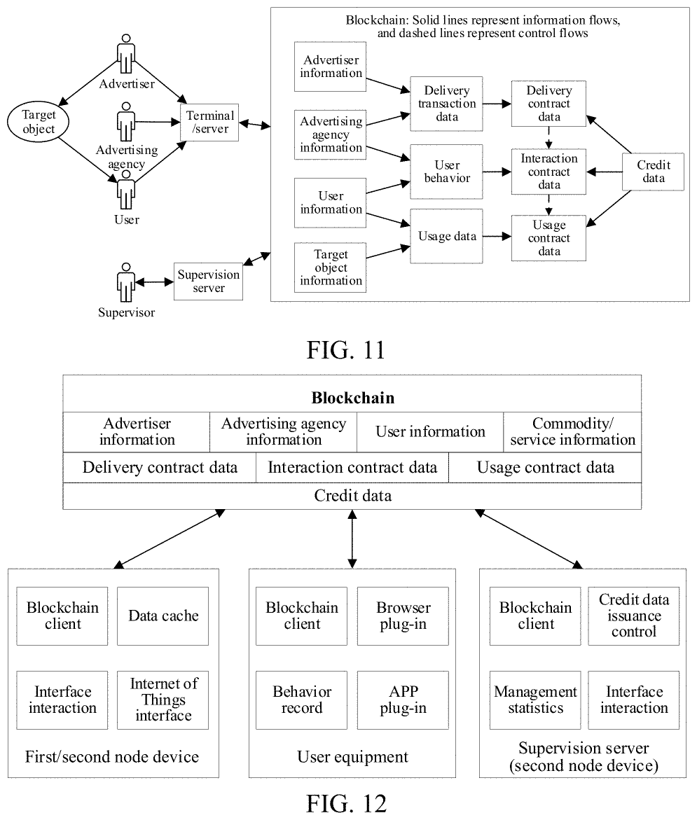

FIG. 11 is a flowchart of a credit data management system according to an embodiment of the present disclosure. Referring to FIG. 11, an advertising agency, an advertiser, and a user all may access the credit data management system through a user equipment, and a supervisor may intervene and monitor behaviors of participants through a management system. In a blockchain network, any of the contract data described in the embodiment shown in FIG. 2 may be generated through interaction of two or three of the advertiser, the advertising agency, and the receiver user, and status of contract fulfilment is updated in real time with a browsing behavior and an interaction behavior to a target content item and a usage behavior to a target object. Information about the contract participants is uploaded by themselves and may be used only after being verified by a supervisor. The contract participants may refer to any one of the advertiser, the advertising agency, and any receiver user.

The credit data (credit currency) involved in the above embodiments serves as security deposit for a contract and a currency to guarantee contract performance, which plays a role of rewarding and punishing. The credit data may be generated by proving a workload of the blockchain. No currency is generated through mining herein, that is, all terminals performs free-of-charge mining. The credit data is uniformly distributed by the credit data management system according to needs. Both the first user which is an advertiser and the second user which is an advertising agency need to pay a fixed amount of guarantees to purchase credit data as respective credit endorsements. Upon completion of the purchase of credit data, values of credit data stored in the accounts of the first user and the second user may represent respective credit status.

Referring to FIG. 12, the first node device and the second node device may include four modules: a blockchain client, a data cache module, an interface interaction module, and an Internet of Things interface. The blockchain client is responsible for participating in the credit data management system, including maintaining a consensus mechanism, acquiring a target block structure of required data from the blockchain point to point, returning related data to a node device, generating and controlling transaction data, and maintaining a credit data processing logic for any contract data. For example, for a specific implementation solution, reference may be made to the Ethereum. The data cache module is configured to temporarily store the acquired target block structure and store contract data related to an account. The interface interaction module is responsible for displaying data recorded in the blockchain to a user in languages, converting information entered by the user into a fixed data format, returning the information to the blockchain client, and recording the information into a new block on the blockchain network. For example, for a contract signed offline, text content of the contract needs to be coded, and a trained natural language processing module and code generation module needs to be embedded in the blockchain. The natural language processing module may be the Tencent Cloud, and the code generation module is usually a deep neural network. The Internet of Things interface is responsible for generating a relationship with actual target objects, for example, collecting actual use status and integrity of various commodities or service accepting status of the user, including but not limited to data generated and uploaded by a built-in status reporting apparatus such as an intelligent home appliance, a smartphone, an intelligent vehicle, on-line evaluation, intelligent monitoring, or the like.

A user interface includes four modules: a blockchain client, a browser plug-in, a behavior record module, and an APP plug-in. The user interface may be built in a browser, an APP, and security software for displaying credit data of an advertiser, an advertising agency, and a target object and collecting behavior information between a user and a target content item. The blockchain client has the same principle and function as the blockchain client in the first node device and the second node device, and therefore details are not described herein. In the browser plug-in and the APP plug-in, when a mouse of the user is moved to the target content item, the credit data of the advertiser related to the target content item may be displayed through a floating menu. When the credit data of the advertiser is less than a second preset value, the user is promptly reminded of a transaction risk. The behavior record module tracks an exposure behavior, a click/tap behavior, an interaction behavior, and a transaction behavior of the user to the target content item, records behavior information of the user, and returns the behavior information to the blockchain client module as a target trigger to trigger a next processing step of the interaction contract data.

The supervision server includes four modules: a blockchain client, a credit data distribution control module, a management and statistics module, and an interface interaction module, which are configured to provide reliable system operation information for the supervisor and acquire information to be counted by traversing each block in the blockchain. In an embodiment, the information to be counted is acquired by incrementally accessing a newest block. The blockchain client has the same principle and function as the blockchain client in the first node device and the second node device, and therefore details are not described herein. The interface interaction module is responsible for displaying a fluctuating indicator of the credit data and can draw a chart. The currency issuance control module may provide a credit data exchange service for the advertising agency and the advertiser according to an amount of mortgages, and provide a service of exchanging legal tender with credit data for the user according to an amount of credit data owned by the user.

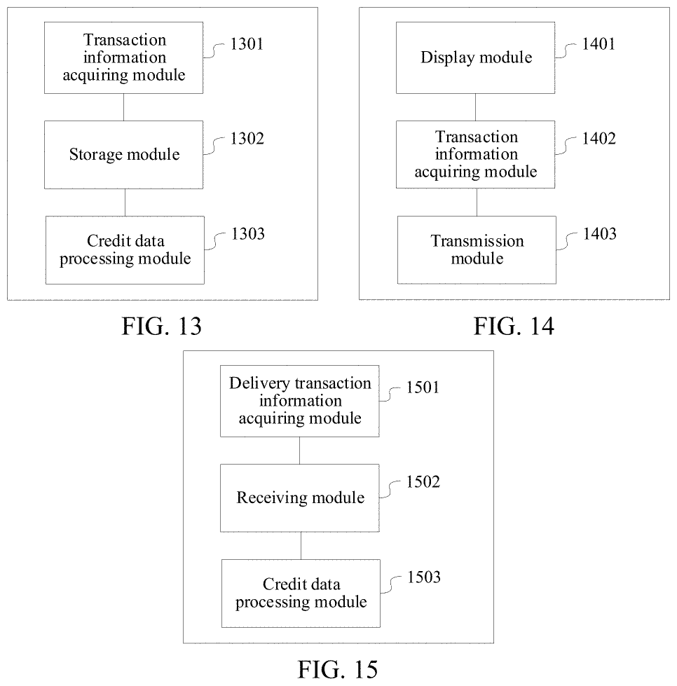

FIG. 13 is a schematic structural diagram of a credit data management apparatus according to an embodiment of the present disclosure. The apparatus may be a user equipment, or may be disposed on the user equipment. The apparatus includes modules or units. All or a part of each of the modules or units may be implemented by software, hardware, or a combination thereof. Referring to FIG. 13, the apparatus includes:

a transaction information acquiring module 1301 configured to acquire delivery transaction information of a first user through a content item delivery interface, the delivery transaction information being used for indicating a delivery transaction between the first user and a second user that is performed for delivery of a target content item, the first user being a provider of a target object corresponding to the target content item, and the second user being a provider of a delivery service;

a storage module 1302 configured to store delivery contract data in a blockchain of a blockchain system according to the delivery transaction information, the delivery contract data being used for indicating a delivery logic for the target content item and credit data processing information;

the storage module 1302 being further configured to store delivery behavior information in the blockchain of the blockchain system during the delivery of the target content item; and

a credit data processing module 1303 configured to process credit data of the second user according to the credit data processing information when the delivery behavior information does not satisfy the delivery logic in the delivery contract data.

The apparatus provided in the embodiments of the present disclosure generates delivery contract data on a credit data management system, and binds a publisher for a delivery behavior based on the delivery contract data. When any delivery behavior and any delivery contract data fail to satisfy the delivery contract data, a corresponding credit data penalty may be imposed on the advertiser. Since the delivery contract data is generated in a blockchain, it is impossible to falsify and tamper with a processing logic for credit data, that is, it is impossible to falsify and tamper with processing of the credit data based on the processing logic. Therefore, authenticity of the credit data is ensured, and integrity of an advertising agency is accurately mirrored by the credit data.

In a possible implementation, the storage module 1302 is further configured to store interaction contract data of any receiver user in the blockchain of the blockchain system after the target content item is delivered to the receiver user, the interaction contract data being used for indicating an interaction processing logic for the target content item.

The storage module 1302 is further configured to store usage contract data of the user in the blockchain of the blockchain system according to received interaction information when the interaction information satisfies a usage contract generation logic in the interaction contract data, the usage contract data being used for indicating a credit data processing logic for a participant of the usage contract data.

The apparatus further includes: a receiving module configured to receive usage data of the target object.

The credit data processing module 1303 is further configured to process credit data of a participant of the interaction contract data according to the usage data and the usage contract data of the target object.

In a possible implementation, the credit data processing module 1303 is configured to:

debit first credit data from an account of the first user when the usage data of the target object is negative evaluation information and the negative evaluation information satisfies a penalty logic in the usage contract data; or

debit second credit data from an account of the second user when the usage data of the target object is negative evaluation information and the negative evaluation information satisfies a penalty logic for the delivery contract data; or

transfer third credit data from the account of the second user to the account of the user when the usage data of the target object is negative evaluation information and the negative evaluation information satisfies the penalty logic in the usage contract data.

In a possible implementation, the credit data processing module 1303 is configured to:

add fourth credit data to an account of the first user when the usage contract data further includes an award logic, the usage data of the target object is positive evaluation information, and the positive evaluation information satisfies the award logic in the usage contract data.

In a possible implementation, the credit data processing module 1303 is configured to: process credit data of the second user according to credit data processing information when the received interaction information does not satisfy a delivery logic in delivery contract data.

In a possible implementation, the apparatus further includes an association module configured to determine the first user in the delivery contract data according to the usage contract data, and associate the target object with an account of the first user.

In a possible implementation, after the target content item is delivered to a receiver user, interaction information between the receiver user and the target content item is stored in the blockchain of the blockchain system.

In a possible implementation, the interaction information includes: exposure information, click/tap information, transaction information, and usage data of the target content item.

In a possible implementation, the target object to which the target content item corresponds includes a commodity or a service.

In a possible implementation, the content item delivery interface includes information about historical content item delivery of the first user.

All of the above optional technical solutions may be combined randomly to form optional embodiments of the present disclosure. Details are not described herein again.

During credit data management by the credit data management apparatus provided in the above embodiments, only division of the functional modules is illustrated. In actual application, the functions may be assigned to different functional modules for completion as required. In other words, an internal structure of the device is divided into different functional modules to complete all or a part of the functions described above. In addition, the credit data management apparatus provided in the above embodiments belong to the same idea as the credit data management method embodiment. For a specific implementation thereof, refer to the method embodiment, and the details are not described herein again.

FIG. 14 is a schematic structural diagram of a content item delivery apparatus according to an embodiment of the present disclosure. The apparatus may be a user equipment, or may be disposed on the user equipment. The apparatus includes modules or units. All or a part of each of the modules or units may be implemented by software, hardware, or a combination thereof. Referring to FIG. 14, the apparatus includes:

a display module 1401 configured to display a content item delivery interface, the content item delivery interface being configured to provide a content item delivery service;

a transaction information acquiring module 1402 configured to acquire delivery transaction information of a target content item based on various entries provided by the content item delivery interface; and

a transmitting module 1403 configured to transmit the delivery transaction information to a blockchain system.

The apparatus provided in the embodiments of the application provides the content item delivery interface, so that the delivery transaction information can be transmitted to the blockchain system, and it is impossible to falsify or tamper with the delivery transaction information, thus ensuring authenticity of the delivery transaction data and reducing risks for delivery transactions between an advertising agency and an advertiser.

In a possible implementation, the content item delivery interface includes a publisher selection option, the publisher selection option being configured to select a publisher.

In a possible implementation, the content item delivery interface includes information about historical content item delivery of a user.

All of the above optional technical solutions may be combined randomly to form optional embodiments of the present disclosure. Details are not described herein again.

During content delivery by the content delivery apparatus provided in the above embodiments, only division of the functional modules is illustrated. In actual application, the functions may be assigned to different functional modules for completion as required. In other words, an internal structure of the device is divided into different functional modules to complete all or a part of the functions described above. In addition, the credit content delivery apparatus provided in the above embodiments belong to the same idea as the content delivery method embodiment. For a specific implementation thereof, refer to the method embodiment, and the details are not described herein again.

FIG. 15 is a schematic structural diagram of a credit data management apparatus according to an embodiment of the present disclosure. The apparatus may be a node device, or may be disposed at the node device. The apparatus includes modules or units. All or a part of each of the modules or units may be implemented by software, hardware, or a combination thereof. Referring to FIG. 15, the apparatus includes:

a delivery transaction information acquiring module 1501 configured to acquire delivery transaction information of a first user through a content item delivery interface, the delivery transaction information being used for indicating a delivery transaction between the first user and a second user that is performed for delivery of a target content item, the first user being a provider of a target object corresponding to the target content item, and the second user being a provider of a delivery service;

a receiving module 1502 configured to receive interaction information of the target content item after the target content item is delivered to a receiver user; and

a credit data processing module 1503 configured to process credit data of the second user according to credit data processing information when the received interaction information does not satisfy a delivery logic in delivery contract data.

The apparatus provided in the embodiments of the present disclosure acquires the delivery transaction information of the first user, to receive the interaction information between receiver user and the target content item. Since the interaction information is received in the blockchain, it is impossible to falsify or tamper with the interaction information. Therefore, when the interaction information does not satisfy the delivery logic in the delivery contract data, that is, when the interaction information cannot achieve an interaction effect agreed in a delivery contract, the credit data of the second user can be processed according to the credit data processing information. Therefore, authenticity of the credit data is ensured, and integrity of an advertising agency is accurately mirrored by the credit data.

During credit data management by the credit data management apparatus provided in the above embodiments, only division of the functional modules is illustrated. In actual application, the functions may be assigned to different functional modules for completion as required. In other words, an internal structure of the device is divided into different functional modules to complete all or a part of the functions described above. In addition, the credit data management apparatus provided in the above embodiments belong to the same idea as the credit data management method embodiment. For a specific implementation thereof, refer to the method embodiment, and the details are not described herein again.

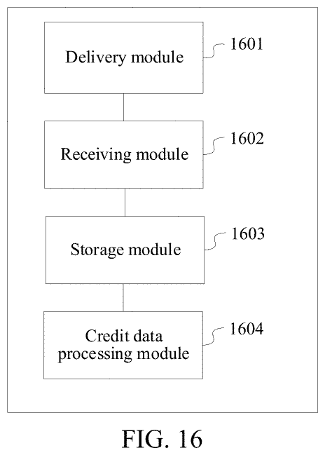

FIG. 16 is a schematic structural diagram of a credit data management apparatus according to an embodiment of the present disclosure. The apparatus may be a node device, or may be disposed at the node device. The apparatus includes modules or units. All or a part of each of the modules or units may be implemented by software, hardware, or a combination thereof. Referring to FIG. 16, the apparatus includes:

a delivery module 1601 configured to deliver a target content item of a first user to a user equipment of a receiver user;

a receiving module 1602 configured to receive interaction information of the user equipment for the target content item;

a storage module 1603 configured to store usage contract data of a receiver user corresponding to the user equipment in a blockchain of a blockchain system according to the interaction information, the usage contract data being used for indicating a credit data processing logic;

the receiving module 1602 being further configured to receive usage data of a target object corresponding to the target content item; and

a credit data processing module 1604 configured to process credit data of the first user and/or a second user which is a publisher according to the usage data of the target object and the usage contract data.

The apparatus provided in the embodiments of the present disclosure receives the interaction information, stores the usage contract data in the blockchain according to the interaction information, and can subsequently receive the usage data, to process the credit data of the first user or the second user or both according to the usage data and the usage contract data. Since the usage contract data and the usage data are generated in the blockchain, it is impossible to falsify and tamper with the processing logic for credit data, that is, it is impossible to falsify and tamper with processing of the credit data based on the processing logic. Therefore, authenticity of the credit data is ensured, and integrity of an advertising agency and an advertiser is accurately mirrored by the credit data.

During credit data management by the credit data management apparatus provided in the above embodiments, only division of the functional modules is illustrated. In actual application, the functions may be assigned to different functional modules for completion as required. In other words, an internal structure of the device is divided into different functional modules to complete all or a part of the functions described above. In addition, the credit data management apparatus provided in the above embodiments belong to the same idea as the credit data management method embodiment. For a specific implementation thereof, refer to the method embodiment, and the details are not described herein again.

Each module/unit and/or submodule/subunit in various disclosed embodiments can be integrated in a processing unit, or each module/unit and/or submodule/subunit can exist separately and physically, or two or more modules/units and/or submodule/subunit can be integrated in one unit. The modules/units and/or submodule/subunit as disclosed herein can be implemented in the form of hardware (e.g., processing circuitry and/or memory) or in the form of software functional unit(s) (e.g., developed using one or more computer programming languages), or a combination of hardware and software.

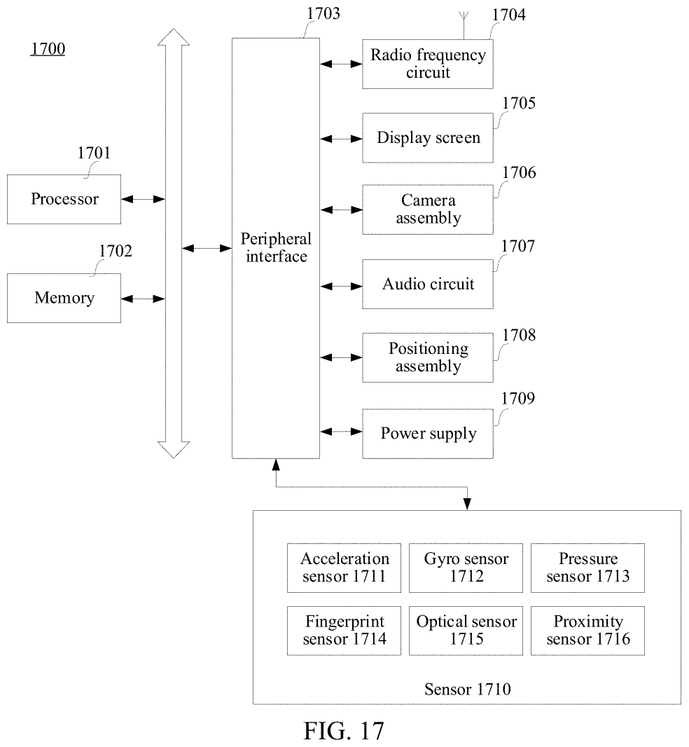

FIG. 17 is a structural block diagram of a user equipment according to an embodiment of the present disclosure. The user equipment 1700 may be a smartphone, a tablet computer, a moving picture experts group audio layer III (MP3) player, a moving picture experts group audio layer IV (MP4) player, a notebook computer, or a desktop computer. The user equipment 1700 may also be referred to as other names such as a portable user equipment, a laptop user equipment, a desktop user equipment, or the like.

The user equipment 1700 usually includes a processor 1701 and a memory 1702.

The processor 1701 may include one or more processing cores, such as a 4-core processor, an 8-core processor, and the like. The processor 1701 may be implemented by using at least one of the following hardware forms: digital signal processor (DSP), a field-programmable gate array (FPGA), and a programmable logic array (PLA). The processor 1701 may also include a main processor and a coprocessor. The main processor is configured to process data in a wake-up state, which is also referred to as a central processing unit (CPU). The coprocessor is configured to process data in a standby state with low power consumption. In some embodiments, the processor 1701 may be integrated with a graphics processing unit (GPU). The GPU is configured to render and draw content that needs to be displayed on a display screen. In some embodiments, the processor 1701 may further include an artificial intelligence (AI) processor. The AI processor is configured to process computing operations related to machine learning.

The memory 1702 may include one or more computer-readable storage media that may be non-transitory. The memory 1702 may further include a high-speed random access memory and a non-volatile memory, for example, one or more magnetic disk storage devices and flash storage devices. In some embodiments, the non-transitory computer-readable storage medium in the memory 1702 is configured to store at least one instruction. The at least one instruction is used to be executed by the processor 1701 to implement the content item delivering method provided in the method embodiments of the present disclosure.

In some embodiments, the user equipment 1700 may optionally include a peripheral interface 1703 and at least one peripheral device. The processor 1701, the memory 1702, and the peripheral interface 1703 may be connected through a bus or a signal line. Each peripheral device may be connected to the peripheral interface 1703 through a bus, a signal line, or a circuit board. Specifically, the peripheral device includes at least one of a radio frequency circuit 1704, a touch display screen 1705, a camera assembly 1706, an audio circuit 1707, a positioning assembly 1708, and a power supply 1709.

The peripheral interface 1703 may be configured to connect at least one peripheral device related to input/output (I/O) to the processor 1701 and the memory 1702. In some embodiments, the processor 1701, the memory 1702, and the peripheral interface 1703 are integrated on the same chip or the same circuit board. In some other embodiments, any or both of the processor 1701, the memory 1702, and the peripheral interface 1703 may be implemented on an independent chip or circuit board, which is not limited in this embodiment.

The radio frequency circuit 1704 is configured to receive and transmit a radio frequency (RF) signal that is also referred to as an electromagnetic signal. The radio frequency circuit 1704 communicates with a communication network and other communication devices through the electromagnetic signal. The radio frequency circuit 1704 converts an electrical signal into an electromagnetic signal for transmission, or converts a received electromagnetic signal into an electrical signal. In an embodiment, the radio frequency circuit 1704 includes an antenna system, an RF transceiver, one or more amplifiers, a tuner, an oscillator, a digital signal processor, a codec chipset, a user identity module card, and the like. The radio frequency circuit 1704 may communicate with other user equipment through at least one wireless communication protocol. The wireless communication protocol includes but is not limited to a metropolitan area network, various generations of mobile communication networks (2G, 3G, 4G, and 5G), a wireless local area network, and/or a wireless fidelity (WiFi) network. In some embodiments, the radio frequency circuit 1704 may further include a near field communication (NFC)-related circuit, which is not limited in the present disclosure.

The display screen 1705 is configured to display a user interface (UI). The UI may include graphics, text, icons, videos, and any combination thereof. When the display screen 1705 is a touch display screen, the display screen 1705 further has a capability of collecting a touch signal on or above a surface of the display screen 1705. The touch signal may be inputted to the processor 1701 as a control signal for processing. In this case, the display screen 1705 may be further configured to provide a virtual button and/or a virtual keyboard that are/is also referred to as a soft button and/or a soft keyboard. In some embodiments, there may be one display screen 1705 disposed on a front panel of the user equipment 1700. In other embodiments, there may be at least two display screens 1705 that are respectively disposed on different surfaces of the user equipment 1700 or folded. In still other embodiments, the display screen 1705 may be a flexible display screen disposed on a curved surface or a folded surface of the user equipment 1700. The display screen 1705 may also be set to a non-rectangular irregular pattern, that is, a special-shaped screen. The display screen 1705 may be made of materials such as a liquid crystal display (LCD), an organic light-emitting diode (OLED), and the like.

The camera assembly 1706 is configured to collect images or videos. In an embodiment, the camera assembly 1706 includes a front camera and a rear camera. Generally, the front camera is disposed on the front panel of the user equipment, and the rear camera is disposed on the back of the user equipment. In some embodiments, there are at least two rear cameras, which are respectively any of a main camera, a depth-of-field camera, a wide-angle camera, and a telephoto camera, to achieve background blur through fusion of the main camera and the depth-of-field camera, panoramic photographing and virtual reality (VR) photographing through fusion of the main camera and the wide-angle camera, or other fusion photographing functions. In some embodiments, the camera assembly 1706 may further include a flashlight. The flashlight may be a single-color-temperature flashlight or a dual-color-temperature flashlight. The dual-color-temperature flashlight is a combination of a warm flashlight and a cold flashlight, which may be used for light compensation at different color temperatures.

The audio circuit 1707 may include a microphone and a speaker. The microphone is configured to collect sound waves of users and surroundings, and convert the sound waves into electrical signals and input the signals to the processor 1701 for processing, or input the signals to the radio frequency circuit 1704 to implement voice communication. For stereo collection or noise reduction, there may be a plurality of microphones that are respectively disposed at different portions of the user equipment 1700. The microphone may also be an array microphone or an omnidirectional collection microphone. The speaker is configured to convert the electrical signal from the processor 1701 or the radio frequency circuit 1704 into sound waves. The speaker may be a traditional thin-film speaker or a piezoelectric ceramic speaker. When the speaker is a piezoelectric ceramic speaker, electrical signals can be converted into not only sound waves that can be heard by human beings but also sound waves that can be heard by human beings for ranging and the like. In some embodiments, the audio circuit 1707 may further include a headphone jack.

The positioning assembly 1708 is configured to determine a current geographical position of the user equipment 1700, to implement navigation or a location based service (LBS). The positioning assembly 1708 may be based on the Global Positioning System (GPS) of the United States, the Beidou System of China, the GLONASS System of Russia, or the Galileo system of the European Union.

The power supply 1709 is configured to supply power to assemblies in the user equipment 1700. The power supply 1709 may be an alternating current battery, a direct current battery, a disposable battery, or a rechargeable battery. When the power supply 1709 includes a rechargeable battery, the rechargeable battery may support wired charging or wireless charging. The rechargeable battery may be further configured to support a fast charging technology.

In some embodiments, the user equipment 1700 further includes one or more sensors 1710. The one or more sensors 1710 include but are not limited to an acceleration sensor 1711, a gyro sensor 1712, a pressure sensor 1713, a fingerprint sensor 1714, an optical sensor 1715, and a proximity sensor 1716.

The acceleration sensor 1711 may detect acceleration on three coordinate axes of a coordinate system established by using the user equipment 1700. For example, the acceleration sensor 1711 may be configured to detect components of gravity acceleration on the three coordinate axes. The processor 1701 may control the touch display screen 1705 to display a user interface in a landscape view or a portrait view according to a gravity acceleration signal collected by the acceleration sensor 1711. The acceleration sensor 1711 may be further configured to collect data of a game or a user movement.

The gyro sensor 1712 may detect a body direction and a rotation angle of the user equipment 1700, and the gyro sensor 1712 may cooperate with the acceleration sensor 1711 to collect a 3D action performed by a user on the user equipment 1700. The processor 1701 may implement the following functions according to the data collected by the gyro sensor 1712: motion sensing (for example, change of the UI based on a tilt operation of the user), image stabilization during photographing, game control, and inertial navigation.

The pressure sensor 1713 may be disposed at a side frame of the user equipment 1700 and/or a layer under the touch display screen 1705. When the pressure sensor 1713 is disposed at the side frame of the user equipment 1700, a grip signal of the user on the user equipment 1700 may be detected, and the processor 1701 may perform left-right hand recognition or a shortcut operation according to the grip signal collected by the pressure sensor 1713. When the pressure sensor 1713 is disposed at the layer under the touch display screen 1705, the processor 1701 controls an operable control on the UI interface according to a pressure operation performed by the user on the touch display screen 1705. The operable control includes at least one of a button control, a scroll bar control, an icon control, and a menu control.

The fingerprint sensor 1714 is configured to collect a fingerprint of a user, and the processor 1701 recognizes an identity of the user according to the fingerprint collected by the fingerprint sensor 1714, or the fingerprint sensor 1714 recognizes the identity of the user based on the collected fingerprint. When the identity of the user is recognizes as credible, the processor 1701 authorizes the user to perform a related sensitive operation. The sensitive operation includes screen unlocking, viewing of encrypted information, software downloading, payment, setting changing, and the like. The fingerprint sensor 1714 may be disposed at the front, the back, or the side of the user equipment 1700. When a physical button or a manufacturer logo is disposed on the user equipment 1700, the fingerprint sensor 1714 may be integrated with the physical button or the manufacturer logo.

The optical sensor 1715 is configured to collect ambient light intensity. In an embodiment, the processor 1701 may control display brightness of the touch display 1705 according to the ambient light intensity collected by the optical sensor 1715. Specifically, when the ambient light intensity is relatively high, the display brightness of the touch display 1705 is increased. When the ambient light intensity is relatively low, the display brightness of the touch display 1705 is reduced. In another embodiment, the processor 1701 may further dynamically adjust a photographing parameter of the camera assembly 1706 according to the ambient light intensity collected by the optical sensor 1715.

The proximity sensor 1716, also referred to as a distance sensor, is usually disposed on the front panel of the user equipment 1700. The proximity sensor 1716 is configured to collect a distance between the user and the front of the user equipment 1700. In an embodiment, when the proximity sensor 1716 detects that the distance between the user and the front of the user equipment 1700 is gradually smaller, the processor 1701 controls the touch display 1705 to be switched from a screen-on state to a screen-off state. When the proximity sensor 1716 detects that the distance between the user and the front of the user equipment 1700 is gradually larger, the processor 1701 controls the touch display 1705 to be switched from the screen-off state to the screen-on state.

A person skilled in the art may understand that the structure shown in FIG. 15 does not constitute a limitation on the user equipment 1700, and the user equipment may include more or fewer assemblies than those shown in the figure, a combination of some assemblies, or different assembly arrangements.

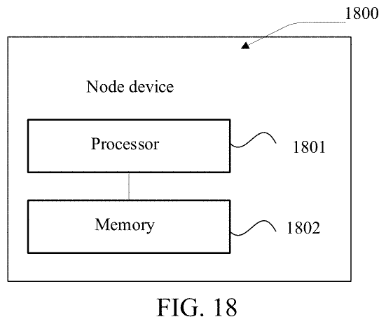

FIG. 18 is a schematic structural diagram of a node device according to an embodiment of the present disclosure. The node device 1800 may vary greatly in configurations or performance, which may include one or more central processing units (CPU) 1801 and one or more memories 1802. The memory 1802 stores at least one instruction, the at least one instruction being loaded and executed by the processor 1801 to implement the credit data management method or the content item delivery method provided in the above method embodiments. Certainly, the node device may further have components such as a wired or wireless network interface, a keyboard, and an input/output interface for inputting and outputting. The node device may further include other components for implementing device functions. Details are not described herein.

In an exemplary embodiment, a computer readable storage medium is further provided, for example, a memory including an instruction. The instruction may be executed by a processor in a terminal to complete the credit data management method or the content item delivery method in the above embodiments. For example, the computer readable storage medium may be a ROM, a random access memory (RAM), a CD-ROM, a magnetic tape, a floppy disk, an optical data storage device, and the like.

It is to be understood that, although the steps are displayed sequentially according to the instructions of the arrows in the flowcharts of the embodiments, these steps are not necessarily performed sequentially according to the sequence instructed by the arrows. Unless otherwise clearly described in this specification, a sequence of performing the steps is not strictly limited, and the steps may be performed in another sequence. In addition, at least some steps in the embodiments may include a plurality of sub-steps or a plurality of stages. The sub-steps or stages are not necessarily performed at a same moment, and instead may be performed at different moments. The sub-steps or stages are not necessarily sequentially performed, and instead the sub-steps or stages and at least some of other steps or sub-steps or stages of other steps may be performed by turns or alternately.

A person of ordinary skill in the art may understand that all or some of the steps of the foregoing embodiments may be implemented by using hardware, or may be implemented by a program instructing relevant hardware. The program may be stored in a computer-readable storage medium. The above-mentioned storage medium may be a read-only memory, a magnetic disk, an optical disc, or the like.

The foregoing descriptions are merely exemplary embodiments of the present disclosure, but are not intended to limit the present disclosure. Any modification, equivalent replacement, or improvement made within the spirit and principle of the present disclosure shall fall within the protection scope of the present disclosure.

What is claimed is:

1. A credit data management method performed by a node device, the method comprising:
acquiring delivery transaction information of a first user through a content item delivery interface, the delivery transaction information indicating information about a delivery transaction of a target content item related to the first user and a second user, the first user being a provider of a target object corresponding to the target content item, and the second user being a deliverer of the target content item;
storing delivery contract data in a blockchain of a credit data management system according to the delivery transaction information, the delivery contract data indicating a delivery logic for the target content item and credit data processing information;
storing delivery behavior information in the blockchain of the credit data management system during a process of delivering the target content item; and
processing credit data of the second user according to the credit data processing information when the delivery behavior information does not satisfy the delivery logic in the delivery contract data.

2. The method according to claim 1, further comprising:
storing, after the target content item is delivered to a receiver user, interaction contract data of the receiver user in the blockchain of the credit data management system, the interaction contract data indicating an interaction processing logic for the target content item;
storing usage contract data of the receiver user in the blockchain of the credit data management system according to received interaction information when the interaction information satisfies a usage contract generation logic in the interaction contract data, the usage contract data indicating a credit data processing logic for a participant of the usage contract data;
receiving usage data of the target object; and
processing credit data of a participant of the delivery contract data according to the usage data of the target object and the usage contract data.

3. The method according to claim 2, wherein the processing credit data of a participant of the delivery contract data according to the usage data of the target object and the usage contract data comprises:
debiting first credit data from an account of the first user when the usage data of the target object is negative evaluation information and the negative evaluation information satisfies a penalty logic in the usage contract data.

4. The method according to claim 2, wherein the processing credit data of a participant of the delivery contract data according to the usage data of the target object and the usage contract data comprises:
debiting second credit data from an account of the second user when the usage data of the target object is negative evaluation information and the negative evaluation information satisfies a penalty logic in the delivery contract data.

5. The method according to claim 2, wherein the processing credit data of a participant of the delivery contract data according to the usage data of the target object and the usage contract data comprises: transferring third credit data from an account of the first user to an account of the receiver when the usage data of the target object is negative evaluation information and the negative evaluation information satisfies a penalty logic in the usage contract data.

6. The method according to claim 2, wherein the processing credit data of a participant of the delivery contract data according to the usage data of the target object and the usage contract data comprises:
adding fourth credit data to an account of the first user when the usage contract data further comprises an award logic, when the usage data of the target object is positive evaluation information, and the positive evaluation information satisfies the award logic in the usage contract data.

7. The method according to claim 2, further comprising:
processing credit data of the second user according to the credit data processing information when the received interaction information does not satisfy the delivery logic in the delivery contract data.

8. The method according to claim 2, further comprising:
determining the first user in the delivery contract data according to the usage contract data, and associating the target object with an account of the first user.

9. The method according to claim 2, wherein the interaction information comprises: exposure behavior information, click/tap behavior information, interaction behavior information, and transaction information of the target content item.

10. The method according to claim 1, further comprising:
storing, after the target content item is delivered to a receiver user, interaction information between the receiver user and the target content item in the blockchain of the credit data management system.

11. The method according to claim 1, wherein the target object to which the target content item corresponds comprises a commodity or a service.

12. The method according to claim 1, wherein the content item delivery interface comprises information about historical content item delivery of the first user.

13. A node device, comprising: one or more processors and a memory storing at least one computer readable instruction, the computer readable instruction being loaded and executed by the one or more processors to implement:
acquiring delivery transaction information of a first user through a content item delivery interface, the delivery transaction information indicating information about a delivery transaction of a target content item related to the first user and a second user, the first user being a provider of a target object corresponding to the target content item, and the second user being a deliverer of the target content item;
storing delivery contract data in a blockchain of a credit data management system according to the delivery transaction information, the delivery contract data indicating a delivery logic for the target content item and credit data processing information;
storing delivery behavior information in the blockchain of the credit data management system during a process of delivering the target content item; and
processing credit data of the second user according to the credit data processing information when the delivery behavior information does not satisfy the delivery logic in the delivery contract data.

14. The device according to claim 13, wherein the one or more processors are further configured to execute:
storing, after the target content item is delivered to a receiver user, interaction contract data of the receiver user in the blockchain of the credit data management system, the interaction contract data indicating an interaction processing logic for the target content item;
storing usage contract data of the receiver user in the blockchain of the credit data management system according to received interaction information when the interaction information satisfies a usage contract generation logic in the interaction contract data, the usage contract data indicating a credit data processing logic for a participant of the usage contract data;
receiving usage data of the target object; and
processing credit data of a participant of the delivery contract data according to the usage data of the target object and the usage contract data.

15. The device according to claim 14, wherein the processing credit data of a participant of the delivery contract data according to the usage data of the target object and the usage contract data comprises:
debiting first credit data from an account of the first user when the usage data of the target object is negative evaluation information and the negative evaluation information satisfies a penalty logic in the usage contract data.

16. The device according to claim 14, wherein the processing credit data of a participant of the delivery contract data according to the usage data of the target object and the usage contract data comprises:
debiting second credit data from an account of the second user when the usage data of the target object is negative evaluation information and the negative evaluation information satisfies a penalty logic in the delivery contract data.

17. The device according to claim 14, wherein the processing credit data of a participant of the delivery contract data according to the usage data of the target object and the usage contract data comprises: transferring third credit data from an account of the first user to an account of the receiver when the usage data of the target object is negative evaluation information and the negative evaluation information satisfies a penalty logic in the usage contract data.

18. The device according to claim 14, wherein the processing credit data of a participant of the delivery contract data according to the usage data of the target object and the usage contract data comprises:
adding fourth credit data to an account of the first user when the usage contract data further comprises an award logic, when the usage data of the target object is positive evaluation information, and the positive evaluation information satisfies the award logic in the usage contract data.

19. The device according to claim 14, wherein the one or more processors are further configured to execute:
processing credit data of the second user according to the credit data processing information when the received interaction information does not satisfy the delivery logic in the delivery contract data.

20. One or more non-transitory storage media storing computer readable instructions, the computer readable instructions, when executed by one or more processors, causing the one or more processors to perform:
acquiring delivery transaction information of a first user through a content item delivery interface, the delivery transaction information indicating information about a delivery transaction of a target content item related to the first user and a second user, the first user being a provider of a target object corresponding to the target content item, and the second user being a deliverer of the target content item;
storing delivery contract data in a blockchain of a credit data management system according to the delivery transaction information, the delivery contract data indicating a delivery logic for the target content item and credit data processing information;
storing delivery behavior information in the blockchain of the credit data management system during a process of delivering the target content item; and
processing credit data of the second user according to the credit data processing information when the delivery behavior information does not satisfy the delivery logic in the delivery contract data.
